(19) United States
(12) Patent Application Publication
(10) Pub. No.: US 2026/0049199 A1
(43) Pub. Date: Feb. 19, 2026

(54) COMPOSITE MATERIAL BASED ON CHARCOAL AND POLYMER BINDER

(71) Applicant: MADE OF AIR GMBH, Berlin (DE)

(72) Inventors: Daniel SCHWAAG, Berlin (DE); Oliver Edward Christopher GOULD, Berlin (DE); Victoria LONGÁN RODRÍGUEZ, Berlin (DE); Babureddy RAMACHANDRAREDDY, Berlin (DE)

(73) Assignee: MADE OF AIR GMBH, Berlin (DE)

(21) Appl. No.: 19/102,015

(22) PCT Filed: Aug. 7, 2023
(86) PCT No.: PCT/EP2023/071805

§ 371 Date: Feb. 7, 2025

(30) Foreign Application Priority Data
Aug. 10, 2022 (EP) 22189737.4

(51) Int. Cl. C08K 3/04; B29C 35/02; B29C 43/00; B29C 43/32; B29C 43/50; B29C 43/52; B29K 73/00; B29L 31/10

(52) U.S. Cl. CPC C08K 3/04; B29C 35/02; B29C 43/003; B29C 43/50; B29C 43/52; B29C 2043/3233; B29K 2073/00; B29K 2995/0016; B29L 2031/10; C08K 2201/005

(57) ABSTRACT

Subject of the invention is a composite material comprising charcoal powder which is dispersed in a polymer matrix, wherein the polymer comprises polyfurfuryl alcohol (PFA). The invention also relates to shaped objects comprising the composite material, uses thereof and methods for the production.

The invention relates to a composite material comprising charcoal powder which is dispersed in a polymer matrix, wherein the polymer comprises polyfurfuryl alcohol (PFA). The invention also relates to shaped objects comprising the composite material, uses thereof and methods for the production.

### STATE OF THE ART

Various approaches are presently suggested and investigated for controlling the carbon dioxide content in the atmosphere. One of the most relevant approaches is reducing the carbon dioxide content in the atmosphere by carbon (dioxide) sequestration and storage. For such approaches, it is important to provide functional materials which are on the one hand valuable and have high acceptance for users, and which are on the other hand suitable for efficient storage of carbon in large quantities. Building materials are of special relevance in this regard, because the building and construction sector is responsible for a large share of total worldwide carbon dioxide release. Moreover, building materials are used in high amounts and have the potential to store large quantities of carbon over long time periods. The quantitative effect in CO₂ storage can be calculated as the Global Warming Potential (GWP).

Charcoal (biochar) is produced through the thermal degradation of biomass by oxygen-controlled atmosphere (pyrolysis). It is widely used in agriculture to reduce runoff and increase soil fertility and crop yields. Since charcoal is based on carbon from the atmosphere, it is potentially an interesting material for carbon sequestration and storage. Compared to other carbon storing organics, such as carbohydrates, charcoal displays a high recalcitrance, thereby preventing stored carbon from re-entering the atmosphere after decomposition. As demonstrated by a growing body of data, charcoal can remain stable under normal environmental conditions for hundreds or even thousands of years.

However, until today the use of biochar for permanent carbon storage in functional materials is limited, because charcoal based materials have various drawbacks. For example, composite materials have been proposed in the art in which biochar is included as a filler. However, such composite materials are often insufficient for building applications because of undesirable properties, such as low thermal and chemical resilience and high-water absorption. Besides, such composite materials typically require polymer binders for stability, which have poor environmental footprints.

DE 30 04 466 A1 relates to a method for producing a porous casting core from carbon and binder. However, the product is only an intermediate product for burning in a casting mould. In view of the high porosity above 80% and the binder content below 1%, a stable binder matrix cannot form and the mechanical stability is low. Moreover, it is suggested to use carbon from fossil origin, such as coke or mineral coal. The methods and composites are neither intended, nor suitable for carbon storage in stable functional materials.

WO 2017/089500 A2 relates to the production of a composite material comprising carbon and a binder. In the production process, a porous green body is prepared by calcinating a mixture of carbon and a first binder. Such a calcinated green body is a porous carbonaceous matrix. Subsequently, the porous green body is impregnated with a second binder resin. The carbon is from fossil origin, such as coke or mineral coal. Besides, impregnating a pre-formed carbonaceous green body with liquid binder has various drawbacks. It is generally difficult to impregnate the interior of a calcined green body uniformly with a binder, and thus the product can comprise void spaces and domains without binder or with less binder. For entering the micropores and uniform distribution, the binder must have low viscosity, which results in only partial filling of pores after solvent removal. Moreover, it is a known problem that calcinated objects undergo shrinking, and thus it is difficult to obtain calcinated green bodies which have a precise and uniform shape. The process is also not flexible, because the ratio of carbon to binder resin and the shape of the product cannot be easily adjusted. The environmental footprint of the product is poor because of fossil raw materials and the intermediate calcination step at high temperature. Overall, the methods and composites are neither intended, nor suitable for carbon storage in stable functional materials.

WO 2021/115636 A1 relates to combinations of filler materials with binders. In essence, it is suggested to combine any conceivable filler with any conceivable binder. The disclose does not comprises a practical example, and not even a relevant theoretical example, and is extremely broad and merely speculative. Such a non-enabling disclosure cannot provide relevant guidance to the skilled person in the technical field. The plenty of unrelated components and speculative applications is not more than an invitation to carry out a research program.

Roudsari et al. “A statistical approach to develop biocomposites from epoxy resin, poly(furfuryl alcohol), poly(propylene carbonate), and biochar”, 2017, J. Appl. Pol. Sci., 134, 38, page 45307, discloses composite materials based on epoxy resins and poly(propylene carbonate) (PPC), which comprise relatively low amounts of biochar and poly(furfuryl alcohol), and are prepared with triethylenetetramine as a curing agent. The authors conclude that the PPC should be added to the epoxy/PFA matrix for obtaining good mechanical properties, whereas the amount of biochar should be reduced to 5% or even less (page 2017, right column). Such composite materials and their production are relatively complicated and costly. It is also not desirable to include amine additives into such a composite. It is another disadvantage that the environmental footprint of the composites is relatively high.

CN101293644B relates to foamed metal parts which have the inner surface coated with porous carbon. The foamed metal parts are suitable as catalysts. They are obtained by soaking a porous metal part in a dispersion of precursor compounds, followed by a calcination process in which carbonaceous precursors are converted into carbon material. The precursor solution comprises thermosetting resins and a carbon material, such as activated carbon or carbon nanotubes. The document does not relate to composite materials from a polymer matrix in which a carbon material is dispersed.

EP 4 032 955 A1 relates to fiber-reinforced composite materials, which are obtained from a radically curable mixture comprising curable thermosetting resin, curing agents and fillers. The thermosetting resin is preferably an unsaturated polyester resin and the curing agent is typically a peroxy-compound. The compositions and production methods are relatively complicated and costly, whereas the environmental footprint is relatively high.

In view of the drawbacks of the prior art, there is a continuous need for improved and efficient methods and products for efficient and permanent carbon storage.

### Problem Underlying the Invention

The problem underlying the invention is to provide new materials, uses and methods, which overcome the problems outlined above. Specifically, the problem is to provide improved materials which have an advantageous environmental footprint and Global Warming Potential (GWP). It is a specific problem to provide materials which have a negative carbon dioxide balance and can be used as a carbon sink for storing carbon sequestered from the atmosphere.

It is a special problem to provide such new materials which are suitable for long term storage in high amounts, such as building materials.

It is a further problem of the invention to provide such materials which have high stability, such as thermal, mechanical and chemical stability, such that the carbon storage effect can be achieved over long time periods. The materials should remain stable at high temperature, and preferably have fire retardant or fire barrier properties.

It is a further problem of the invention to provide such materials, which are easily available from conventional raw materials by relatively simple methods. The materials shall be available at low costs and be suitable for mass production, because only then carbon storage in relevant amounts, and a considerable impact on the environment, can be achieved. In contrast, the invention shall not provide a niche product which would only be available from rare materials or by complicated methods.

### DISCLOSURE OF THE INVENTION

Surprisingly, it was found that the problem underlying the invention is overcome by composite materials, shaped objects, uses and methods according to the claims. Further embodiments of the invention are outlined throughout the description.

Subject of the invention is a composite material comprising charcoal powder which is dispersed in a polymer matrix, wherein the polymer comprises polyfurfuryl alcohol (PFA), wherein the composite material comprises 25 to 90 wt. % charcoal and 10 to 75 wt. % polyfurfuryl alcohol.

Polyfurfuryl alcohol (furan resin, CAS 25212-86-6) is a polymer obtained by polycondensation of furfuryl alcohol, typically in the presence of weak acids. The main product of such a polycondensation reaction is a linear polymer. However, it is known in the art that some alternative bonds can be formed during the polycondensation. PFA is a liquid polymer at room temperature. Preferably, the furfuryl alcohol and PFA are biobased, which means that they are derived from biomass. In the art, the building block furfuryl alcohol is typically manufactured industrially by hydrogenation of furfural, which can be produced from waste biomass, such as corn cobs or sugar cane. PFA from biomass building blocks has an excellent environmental footprint.

Charcoal is a lightweight black carbon material which is produced from organic materials, predominantly wood or other plant materials, in a process referred to as pyrolysis in the presence of low amounts of oxygen. The charcoal thus obtained can be grinded or milled into fine powder.

The composite material is characterized by a polymer matrix which comprises PFA. In a preferred embodiment, the polymer matrix consists of PFA. This means that the matrix does not comprise another matrix-forming polymer; whilst the presence of functional additives is not excluded. In a preferred embodiment, the polymer matrix is cured and/or crosslinked. Basically, PFA has properties of a thermoset polymer. When PFA is heated for a sufficient time, it undergoes crosslinking and curing. This means that reactions occur, in which different polymer chains are covalently linked. Overall, a three-dimensional polymer matrix is formed. Addition of a further crosslinking agent is not required, although a crosslinking agent could be added if desired.

The charcoal powder is dispersed throughout the continuous polymer matrix. Thus, the particles, or particle agglomerates, are embedded in the polymer matrix. The charcoal particles or particle agglomerate may contact each other, depending on the ratio of charcoal powder filler to PFA binder and the degree of mixing. In view of the polymer matrix and dispersed particles, the structure is fundamentally different from materials in the art formed by impregnating a calcinated green body with liquid binder.

The use of charcoal in the composite material is highly advantageous for environmental reasons, because 1 kg of charcoal contains approximately 680 to 820 grams of carbon, which is equivalent to about 2.5 to 3 kg carbon dioxide. Thus, when charcoal is permanently stored in the composite material, the atmosphere can be depleted permanently from carbon dioxide in an equivalent amount. This can have a relevant environmental impact if charcoal-based materials are put into use in large amounts, for example in building applications.

Therefore, the inventive combination of PFA from organic sources with charcoal provides a highly advantageous environmental footprint and allows sequestration and permanent storage of carbon from the atmosphere in high amounts. The composite material comprises 25 to 90 wt. % charcoal and 10 to 75 wt. % PFA. Preferably, the composite material comprises 30 to 85 wt. % charcoal and 15 to 70 wt. % PFA; more preferably 40 to 80 wt. % charcoal and 20 to 60 wt. % PFA. It is especially preferred that the ratio of charcoal in the composite is at least 30 wt. %, at least 50 wt. %, or at least 70 wt. %. In these embodiments, it is advantageous that the PFA can confer high stability to the composite. Further, the environmental footprint is especially good when including the charcoal in relatively high amounts. It is preferred that the composite material consists of charcoal and PFA (as the polymer binder), which can render the environmental footprint especially good.

In a preferred embodiment, the charcoal powder has an average particle size of 10 μm to 10 mm, preferably 50 μm to 5 mm, more preferably 100 μm to 1 mm. In a preferred embodiment, the charcoal particles have particle sizes in the range between 10 μm and 10 mm, preferably 50 μm and 5 mm, more preferably 100 μm and 1 mm. Preferably, the particle sizes are determined in the method according to DIN ISO 2591-1:1988. It was found that fine particulate powder with such particle size is suitable for providing composite materials of high uniformity and strength.

In a preferred embodiment, the composite material is not porous. In a preferred embodiment, the composite material is dense and/or does not comprise void space. A non-porous and/or dense material can be obtained if the composition comprising the PFA binder and charcoal powder is moulded and compressed before solidification. A non-porous material is especially advantageous for storage of the maximum amount of carbon. Moreover, the stability and barrier properties of a dense material can be especially high.

In another embodiment, the composite material is porous. For example, it may comprise 1 to 70%, or 2 to 25% by volume voids, such as pores. This can be advantageous for applications in which light weight and/or permeability for fluids, such as air or water, is desired. Non-porous materials can be obtained by conventional means, for example by adding a propellant in the production process.

In a preferred embodiment, the composite material comprises at least one additional filler or reinforcing agent, such as fibers. If additional fillers or reinforcing agents are added, it is preferred that they are also based on organic materials and have a good environmental footprint. Additional fillers could be added for modifying the properties, for example by including colour pigments or conductive particles. Reinforcing agents, such as fibres, especially glass or carbon fibres, could be added for increasing the mechanical stability. Preferably, the amount of fillers and/or reinforcing agents is up to 20%, preferably up to 10%, for example in the range of 1 to 20% or 2 to 10% (w/w).

The composite material may comprise at least one additive which is not a structural polymer, filler or reinforcing agent. For example, the additives can be selected from plasticizers, coupling agents, colorants, processing aids, flame retardants, thermal stabilizers and compatibilizers. For example, processing aids can improve workability in solution, or the moulding procedure, or can confer desired properties to the composite material, such as colour, strength or the like. Preferably, the amount of additives is up to 5% or up to 2%, for example in the range of 0.01 to 5% or 0.1 to 2% (w/w).

In a preferred embodiment, the composite material comprises
(A) 25 to 90%, preferably 30 to 85%, charcoal,
(B) 10 to 75%, preferably 15 to 70%, PFA,
(C) optionally up to 20% fillers and/or reinforcing agents, and
(D) optionally up to 5% additives,
   wherein all % are weight %, wherein the sum of components (A) to (D) is 100%, wherein the additives (D) are not fillers and/or reinforcing agents. The fillers and additives are preferably selected as outlined above.

Subject of the invention is also a shaped object, which comprises the composite material of the invention. As used herein, a shaped object is a discrete solid part or body of defined three-dimensional structure. The shaped object may consist of or may comprise the composite material. Shaped objects can be used, for example, for building, furniture, transport applications. In preferred embodiments, the shaped object is a panel, insulation board, building block or device. The device is a functional object, such as tube, box, pot or piece of furniture. The use of the composite material for preparing such shaped objects is highly advantageous, because they can be obtained easily, reliably and in large numbers by moulding.

In a preferred embodiment, the shaped object is a building material, i.e. a material used for construction. In preferred embodiments, the building material is a panel for walls, an insulation board, a building part, or a block for assembling building parts, such as walls. In furniture applications, the shaped object is preferably a panel or a structural part. It is highly advantageous that such building materials or furniture parts can be obtained conveniently, uniformly and in high numbers by moulding from the composite material.

A panel is a flat object for covering a building or furniture part, such as a wall, floor or furniture surface. The use of the composite material as a panel is especially advantageous, because of the high stability of the composite material. Since the composite material is mechanically, thermally and chemically stable, the panel can shield the substrate to which it is mounted. Moreover, the high thermal stability can protect the substrate against heat or fire.

In preferred embodiments, the panel has an area of 0.05 to 5 m², a thickness of 2 to 50 mm, and a length, which is preferably at least 10 times higher than the thickness. More preferably, the panel has an area of 0.2 to 2 m², a thickness of 2 to 10 mm, and a length which is preferably at least 10 times higher than the thickness. Panels having such dimensions are advantageous, because they can be produced conveniently with conventional moulding devices and procedures, and can be widely used in building or furniture applications.

In a preferred embodiment, the composite material or shaped object is an insulation material. This is advantageous, because the composite material has a high heat capacity. For example, the heat capacity of a composite from 70 wt. % charcoal and 30 wt. % PFA is about 2050 J/kg K, which is comparable to the conventional insulation material extruded polystyrene (XPS).

The composite material and shaped object are highly advantageous compared to respective products, which are obtained by impregnating a pre-formed porous green body of the filler with a binder solution. It is much more complex and difficult to achieve uniform impregnation of pre-shaped green bodies, and much more complicated to shape porous green bodies, than simply moulding and curing an object in desired shape.

The shaped object may be a composite which consists of the inventive composite material and a further material, for example in the form of a laminate consisting of two, three or more layers. In a preferred embodiment, the composite material or shaped object comprises a coating layer (coating). Typically, the coating is a functional coating, which confers a desired property to the substrate. For example, the coatings may confer desired optical properties to the substrate, such as colour or gloss, or may provide protection against moisture, UV radiation, chemical or mechanical damages, or weathering; or which may comprise a texture. Since charcoal confers a dark colour to the composite material, it may be especially desirable to apply a colour coating. Coatings can be applied by conventional means, such as liquid coating procedures, for example with resins, impregnation, electron scattering (Trespa process), physical or chemical vapor deposition, lamination and the like. The coating may cover the shaped object completely or partially, for example only on one surface. For example, a panel may comprise a functional coating only on the outer surface.

Subject of the invention is also the use of the composite material or shaped object as a fire retardant and/or fire barrier. It was found that the composite material has high thermal stability, such that it is suitable for fire protection or as a fire barrier. A fire barrier material can provide a physical barrier against the passage of fluids, fire or sparks at very high temperature, thereby preventing spreading of fire. The low weight loss of the composite material, even at very high temperature, indicates that the material can be suitable for such uses. This is especially advantageous for panels, which can shield the substrate on which they are mounted from the environment.

The shaped object and/or composite material can be used for protection against UV radiation. The inclusion of biochar into the PFA matrix can vastly improve the UV resistance of the building material or the like, thereby reducing the need for UV stabilizing compounds during production, and reducing degradation during use, which also leads to improvements in recyclability.

It is another advantage that biochar as a pyrolysis product can also introduce less thermal load into composites than conventional products, such as Kraft paper.

In principle, the composite material is obtainable by various methods, in which charcoal powder, PFA and a liquid are mixed, consolidated and dried. However, it is highly preferred to produce the composite material by moulding. This is especially advantageous, because liquid composition from charcoal powder and PFA can be moulded and consolidated in a simple and efficient process, in which uniform and highly stable composites can be obtained.

According to the invention, it was found that a moulding process can also be highly advantageous for moisture control. The initial mixture comprises solvent, and further water is released when the PFA binder is cured in the condensation reaction. Charcoal has a porous structure and can absorb moisture into its interior. Without being bound to theory, it is assumed that the charcoal powder can adsorb in its interior moisture and/or solvent, and especially water formed in the condensation reaction, thereby supporting the condensation reaction by shifting the reaction equilibrium towards further curing. From the product properties, it can be concluded that such an uptake of water into the charcoal interior does not negatively affect the stability of the final product. In contrast, the high stability suggests that the overall stability is improved, because an intimately cured and dense product can be obtained. This unique advantage is only observed when combining the adsorptive charcoal filler with the PFA resin capable of further condensation.

Subject of the invention is also a method for producing the composite material or shaped object of the invention, comprising the steps of
(a) preparing a composition comprising charcoal powder, at least one compound selected from polyfurfuryl alcohol (PFA) and furfuryl alcohol, and at least one solvent,
(b) placing the composition into a mould,
(c) subjecting the mould to heat and pressure, and
(d) removing the moulded part from the mould.

Method steps (a) to (d) are carried out in consecutive order. Preferably, the PFA is produced before step (a) by polymerisation from furfuryl alcohol in a polycondensation reaction, typically in the presence of a weak acid, such as maleic anhydride. The polycondensation can be supported by heating, for example at a temperature of 80° C. to 150° C. The PFA resin can be obtained in the form of a liquid polymer. Preferably, the initial moisture content of the biochar is below 5%, typically 1 to 5%, more preferably around 3%. The initial moisture control of the biochar is controlled by drying.

The composition in step (a) can be prepared by mixing the charcoal powder, PFA and solvent in any given order. Preferably, at first a mixture of the PFA and solvent is prepared. The desired viscosity can be controlled by the solvent amount. Subsequently, the PFA/solvent mixture is combined with the charcoal powder. After profound mixing, the uniform composition can be inserted into the mould (moulding form).

Preferably, the ratio of PFA to solvent in the PFA/solvent mixture and/or in the composition is between 50 and 90% PFA to 10 and 50% solvent (w/w), preferably between 60 and 85% PFA to 15 and 40% solvent (w/w), preferably about 70% to 30% (w/w). In a preferred embodiment, the solvent is an aliphatic alcohol, preferably ethanol. Surprisingly, it was found that a mixture of PFA with an aliphatic alcohol, preferably ethanol, can support intimate impregnation of the charcoal, possibly by reducing the PFA viscosity. Thereby, the ethanol can improve the stability of the composite material. Preferably, the mixture comprises essentially no water, for example less than 10% water, or less than 5% water, or less than 2% water. It was found that the workability and product properties can be advantageous when using a mixture of PFA and ethanol, which comprises essentially no water. Alternatively, the solvent may be another organic solvent, such as methanol or propanol.

In an alternative embodiment, in step (a) furfuryl alcohol is used instead of PFA. When proceeding accordingly, PFA is formed from the furfuryl alcohol during the process in situ, when heat and pressure are applied in step (c). Also in this embodiment, the inventive composite which comprises charcoal powder dispersed in a PFA matrix can be obtained.

In subsequent step (c), the mould, and thus the composition in the mould, is subjected to heat and pressure. Preferably, the mould in step (c) is subjected to a temperature between 80° C. and 250° C., typically between 100° C. and 200° C., at a pressure of preferably 2 bar to 50 bar, more preferably 5 bar to 20 bar. The heat has the effect that the PFA is cured at least partially, and that the composition is dried at least partially. Solvent can be removed into the environment and/or adsorbed by the charcoal. The pressure has the effect that solvent can be removed more efficiently and that a dense product can be obtained, which is not porous.

Step (c) can be terminated when the mould has a desired consistency, and typically has become a solid moulded object. The moulded object is removed from the mould in step (d). Preferably, the mould is removed after a time period of 10 min to 8 h, preferably 20 min to 3 h. In an embodiment, the moulded part obtained in step (d) is the composite material.

In a preferred embodiment, after step (d), the moulded part is subjected to heat in step (e). Typically, the moulded part obtained in step (d) is an intermediate product (green body), which is converted into the composite material by further heating in subsequent step (e). Thereby, the curing can be completed and/or the residual moisture can be removed. Preferably, in step (e) the moulded part is heated in an oven, which is typically ventilated for efficient drying, preferably at a temperature between 100° C. and 250° C., typically between 120° C. and 220° C. Thereby, the green body with residual moisture can be converted into the composite material by additional curing and drying. After heating is completed, the composite material of the invention can be obtained.

In a preferred embodiment, the process heat which is generated in the pyrolysis process in which the charcoal is produced, can be used in the heating steps for producing the composite material. This leads to even higher energy efficiency and further improvement of the environmental footprint of the material.

It is advantageous that the inventive composite material can be obtained simply by moulding a liquid mixture of charcoal powder and PFA. Thus, it is not required to produce a carbonaceous green body in an intermediate, which is subsequently impregnated with binder. Accordingly, the inventive process is easier and more convenient than conventional processes, as described in WO2017/089500 A2. The inventive moulding method also provides a novel and advantageous material, because the PFA matrix, in which the charcoal particles are dispersed, can confer high stability to the composite. An intimate and uniform contact of both components can be achieved without void space.

According to the invention, it was found that a stable composite material can be obtained which consists mostly of biochar and PFA. It is preferred that the composite material, and especially the polymer matrix, do not comprise relevant amounts of other constituents. Preferably, the combined amount of biochar and PFA in the composite is >80 wt. %, more preferably >90 wt. % or >95 wt. %. preferably, the polymer matrix consists of PFA.

Preferably, the composition for preparing the composite material does not comprise additional reactive components for forming the polymer matrix. Preferably, the composition does not comprise further curable components, in the form of polymer resins, monomers or additives. Preferably, the composition does not comprise a further component comprising unsaturated groups, such as vinyl groups or acrylic groups, epoxy groups, reactive silicon-based groups, such as siloxane or silane groups, thiol, cyanate or isocyanate groups. Preferably, the composition does not comprise a further thermoset adhesive. It is also preferred, that the composition does not comprise low molecular weight additives for curing, such as a curing agent, crosslinking agent or curing catalyst. Preferably, the composition does not comprise a curing agent, such as a peroxy-compound, active hydrogen-containing compound, anionic or cationic initiator; molecule which can provide an anion, such as a tertiary amine, secondary amine or metal alkoxide. It is preferred that the composite material, and especially the polymer matrix, does not comprise a polyurethane, polyester, polycarboxylate or polyacrylate. It is preferred that the composite material, and especially the polymer matrix, does not comprise an organic polymer comprising N, Si, S and/or P, such as amine, thiol, phosphate or siloxane groups.

Typically, the polymer matrix is the main structural component which confers stability to the composite material. Accordingly, the polymer matrix is not only a coating or a filler of another, different material. The composite material does not comprise a solid body or scaffold from another, different material, such as a solid foam, such as metal foam, or porous green body, such as a carbonaceous scaffold, which is impregnated with a composition comprising PFA or furfuryl alcohol and biochar. The composite material with the polymer matrix is also not an intermediate for further chemical modification in which the polymer matrix is degraded, such as a green body for calcination.

According to this disclosure, the charcoal can be biochar. Charcoal and biochar are both obtained by pyrolysis from organic material. Although the pyrolysis conditions tend to be different, there is not clear distinction between charcoal and biochar. However, charcoal is physically and chemically very different from other carbon products, especially from fossil origin such as bituminous coal or coke, or refined carbon materials such as carbon black, carbon nanotubes or carbon fibers. For example, coke is obtained from oil or bituminous coal and has a much higher density, much lower content of volatiles, and different chemical composition than biochar. These products are generally more refined and expensive than charcoal and biochar and have different properties. In one embodiment, the charcoal and/or biochar has not been subjected to further chemical modification, such as activated carbon (activated charcoal). The advantageous properties can be achieved with simple charcoal or biochar, which can be advantageous for cost reasons.

The inventive composite material, shaped object, uses and methods solve the problem underlying the invention. A highly stable composite material is provided, which has an excellent environmental footprint and can be used as a carbon sink for long-term storage of carbon from the atmosphere, for example in buildings, furniture or the like. The composite material has an unusually high thermal stability, which renders it suitable for flame protection and flame-retardant applications.

It is another advantage of the inventive composite material and production method, that the composite material is available from conventional materials charcoal and furfuryl alcohol, which are easily available at relatively low costs. Moreover, the composite material is obtainable in a simple moulding process and thus suitable for mass production, which is a prerequisite for efficient carbon storage. As outlined above, the moulding process is also advantageous because of moisture control in the binder system.

Further, the starting materials and the composite material are not toxic. This provides an advantage to materials in the art, such as phenolic and formaldehyde based resins. After use, the composite material can be recycled or burnt in a thermal power station.

It is a special advantage that no only the biochar is from natural origin, but also the PFA can be obtained easily from furfuryl alcohol from natural origin, and especially from waste biomass. Biochar and furfuryl alcohol are simple products, which are not highly refined, and available in large amounts at low costs from natural origin. Moreover, it is advantageous that the composite material can comprise high levels of both materials of up to 100%. Therefore, a very good environmental footprint can be achieved.

Moreover, the composite material, the underlying composition, and the production process are very simple, because only two starting materials are required. Thus, it is convenient to control and carry out the inventive reaction. This is a significant advantage compared to systems and composite materials of the prior art, which are based on specific curing reactions, thermoset systems and additives, such as epoxy systems and curing agents.

Overall, the composite material is advantageous compared to conventional products because of low toxicity, high stability and convenient production at low costs. Thereby, an improved material is provided for efficient carbon sequestration and storage in large amounts.

Exemplified embodiments of the invention and aspects of the invention are shown in the FIGURES.

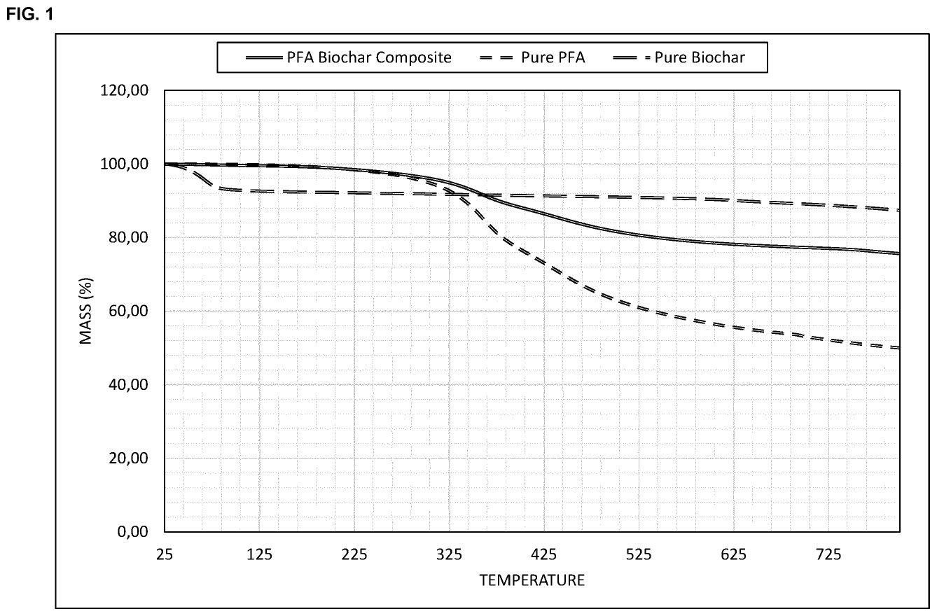

FIG. 1 shows the results of example 2 regarding thermal stability in the range of 25-800° C., as determined by thermogravimetric analysis (TGA), of the composite material and comparative samples. The results are shown for the inventive composite material from PFA and charcoal (continuous line), pure charcoal (dashed, long segments) and pure PFA (dashed, short segments).

### EXAMPLES

### Example 1: Production of Inventive Composite Material

A PFA resin was prepared from furfuryl alcohol (Sigma Aldrich, US) by acid catalysed polymerization. The furfuryl alcohol was mixed with maleic anhydride (2% by weight) at ambient temperature. The mixture was heated to 100° C. for 45 min under magnetic stirring until a fluid PFA resin was obtained. This PFA resin has a pH of 2.8 (measured at 50 w/w % in water) and a density of 1.4.

Biochar was produced by pyrolysis from beechwood derived lignocellulosic biomass. Biochar with a particle size distribution in the range of 100 μm to 1 mm was produced through grinding with an impact mill, before drying at 120° C. for 24 hours, to obtain a biochar with a moisture content of around 3%.

For the production of the composite material, the liquid PFA polymer resin was mixed with ethanol (96%) to an ethanol/PFA ratio of 30:70 (w/w). The ethanol reduces the PFA viscosity and improves the biochar impregnation. The PFA/ethanol mixture was mixed with the biochar to a PFA:biochar ratio of 70:30 (w/w). The composition was inserted into an aluminum mould and heated at 160° C. for 45 min under compression at a pressure of 10 bars. The length of the mould is 105 mm, the width is 60 mm and the thickness is 75 mm. After demoulding, the composite was heated in a ventilated oven for 2 h at 180° C. for completing the curing of PFA and release of volatiles, such as solvent and water from the polycondensation of PFA. A solid shaped object of high stability was obtained.

In further experiments, composites were prepared from compositions with ratios of PFA:biochar of 50:50 and 60:40 (w/w). Solid shaped objects of high stability were also obtained from these compositions.

### Example 2: Thermal Stability of Composite Material

The thermal stability of the composite material of example 1 was examined by thermogravimetric analysis (TGA). The sample weight was determined in the temperature range of 25-800° C. with a temperature ramp of 10° C./min. Comparative samples were also examined which are pure biochar and a corresponding pure PFA product.

The results are shown in FIG. 1. It was found that a biochar-PFA composite with only 30% biochar can provide a significant advantage in thermal resilience, with dramatically reduced thermal degradation. The observed mass loss at 750° C. of approximately 25% demonstrates the high thermal resistance of the material and illustrates its superiority to pure PFA (approx. 50% mass loss). A synergistic improvement in the thermal degradation of the PFA biochar composite was also observed, because the mass loss of the composite material was significantly lower than expected from the combination of the two components alone. The results also demonstrate that essentially no mass loss occurs within the temperature range up to about 250° C. This can be advantageous, because significant changes of the properties can be undesirable in practical applications. In this temperature range, the thermal stability is high and comparable to pure PFA. In comparison, it can be seen that the pure biochar exhibits a considerable weight loss between 20° C. to 80° C. Overall, the thermal behavior provides an advantageous combination of high stability in the range up to about 250° C., with relatively high stability and structural integrity at high temperature up to about 800° C., even when only relatively low amounts of biochar are added. It can be expected that building parts from the composite material will not collapse at high temperature, which renders the material suitable for fire retardant or fire barrier applications.

### Example 3: Environmental Footprint of Composite Material

The environmental footprint for panels from composite material of the invention and comparative building materials, which are conventional HPL and epoxy glass fiber composite, were calculated by various standardized methods. HPL (high-pressure laminate) is a common building material from 60% to 70% paper and 30% to 40% binder based on a combination of phenol-formaldehyde resin and melamine-formaldehyde resin. Epoxy glass fiber composites are common in the art as fire retardant panels for building applications. Calculations were made for Cradle-to-Gate, which is an assessment of a partial product life cycle from resource extraction (cradle) to the factory gate, i. e. before it is transported to the consumer. The calculations were made for panels having an area of 1 m² and thickness of 8 mm. The results demonstrate that the inventive composite material has a highly advantageous environmental footprint (table 1). The inventive composite material has a significantly better environmental footprint than the conventional products. Notably, the CO2 balance of the inventive composite can be negative. Thus, the inventive composite material can be an effective carbon sink, and is suitable for sequestering and storing carbon from the atmosphere.

TABLE 1
Environmental footprint for panels from inventive biochar PFA composite
(BPF), and comparative HPL and epoxy glass fiber composites (EGF)

| Method | BPF | HPL | EGF |
|---|---|---|---|
| 01 EN15804 + A2 Climate Change - total [kg CO2 eq.] | −10.2 | 32.1 | 43.1 |
| 02 EN15804 + A2 Climate Change, fossil [kg CO2 eq.] | 19.4 | 27.2 | 42.2 |
| 03 EN15804 + A2 Climate Change, biogenic [kg CO2 eq.] | −29.7 | 4.91 | 0.884 |
| 04 EN15804 + A2 Climate Change, land use and land use | 0.0085 | 0.0356 | 0.0081 |
| change [kg CO2 eq.] | | | |
| 05 EN15804 + A2 Ozone depletion [kg CFC-11 eq.] | 3.47 × 10⁻¹⁰ | 2.52 × 10⁻⁸ | 2.75 × 10⁻¹⁰ |
| 06 EN15804 + A2 Acidification [Mole of H + eq.] | 0.030 | 0.066 | 0.099 |
| 07 EN15804 + A2 Eutrophication, freshwater [kg P eq.] | 8.77 + 10⁻⁵ | 0.000321 | 0.000224 |
| 08 EN15804 + A2 Eutrophication, marine [kg N eq.] | 0.0078 | 0.0227 | 0.0217 |
| 09 EN15804 + A2 Eutrophication, terrestrial | 0.083 | 0.196 | 0.234 |
| [Mole of N eq.] | | | |
| 10 EN15804 + A2 Photochemical ozone formation, human | 0.020 | 0.066 | 0.071 |
| health [kg NMVOC eq.] | | | |
| 11 EN15804 + A2 Resource use, mineral and metals | 6.97 × 10⁻⁶ | 3.85 × 10⁻⁶ | 8.43 × 10⁻⁶ |
| [kg Sb eq.] | | | |
| 12 EN15804 + A2 Resource use, fossils [MJ] | 215 | 495 | 818 |
| 13 EN15804 + A2 Water use [m³ world equiv.] | 2.5 | 22.5 | 2.9 |

1. A composite material comprising charcoal powder which is dispersed in a polymer matrix, wherein the polymer comprises polyfurfuryl alcohol (PFA), wherein the composite material comprises 25 to 90 wt. % charcoal and 10 to 75 wt. % polyfurfuryl alcohol.

2. The composite material of claim 1, which comprises 25 to 90 wt. % charcoal and 10 to 75 wt. % polyfurfuryl alcohol.

3. The composite material according to claim 1, wherein the charcoal powder has an average particle size of 10 μm to 10 mm, as determined according to DIN ISO 2591-1:1988.

4. The composite material according to claim 1, which is not porous.

5. The composite material according to claim 1, which comprises at least one additional filler and/or reinforcing agent, such as fibers, and/or which comprises at least one additive, such as plasticizers, coupling agents, colorants, processing aids, flame retardants, thermal stabilizers and compatibilizers.

6. A shaped object, which comprises the composite material according to claim 1.

7. The shaped object of claim 6, which is a panel, insulation board, building part, building block or device.

8. The shaped object of claim 7, which is a panel having an area of 0.05 to 5 m², a thickness of 2 to 50 mm, and a length which is at least 10 times higher than the thickness.

9. The composite material or shaped object according to claim 1, which comprises a coating.

10. The composite material or shaped object according to claim 1, which is obtained by moulding and curing.

11. Use of the composite material and/or shaped object according to claim 1 as a fire retardant and/or fire barrier.

12. A method for producing the composite material or shaped material according to claim 1, comprising the steps of
preparing a composition comprising charcoal powder, at least one compound selected from polyfurfuryl alcohol (PFA) and furfuryl alcohol, and at least one solvent,
placing the composition into a mould,
subjecting the mould to heat and pressure, and
removing the moulded part from the mould.

13. The method according to claim 12, wherein the ratio of PFA to solvent in the composition is between 50 and 90% PFA to 50 and 10% solvent (w/w).

14. The method according to claim 12, wherein the solvent is ethanol.

15. The method according to claim 12, wherein after step (d), the moulded part is subjected to heat.
